(19) United States
(12) Patent Application Publication
(10) Pub. No.: US 2019/0093535 A1
(43) Pub. Date: Mar. 28, 2019

(54) SYSTEMS AND METHODS FOR ADJUSTING FOR AFTERTREATMENT SYSTEM CONDITION

(71) Applicant: General Electric Company, Schenectady, NY (US)

(72) Inventors: Maruthi Narasinga Rao Devarakonda, Waukesha, WI (US); Monika Jonuskeviciute, Altanta, GA (US)

(21) Appl. No.: 15/717,911

(22) Filed: Sep. 27, 2017

(51) Int. Cl. F01N 3/20; G05B 13/04

(52) U.S. Cl. CPC F01N 3/208; G05B 13/041; F01N 11/00; F01N 2900/1402; F01N 2610/02; F01N 2900/1622

(57) ABSTRACT

A system includes an aftertreatment system configured to treat emissions from an engine via a catalyst and a controller. The controller is configured to obtain one or more engine signals representative of operations of the engine and to execute a model to derive an estimated catalyst emission based on the one or more engine signals and on an expected catalyst degradation. The controller is further configured to obtain one or more catalyst signals representative of catalyst performance, and to generate an adaptation signal configured to improve accuracy of the model based on the one or more catalyst signals. The controller is also configured to apply the adaptation signal and the estimated catalyst emission to generate a urea injection control signal.

### BACKGROUND

The subject matter disclosed herein relates to power generation systems. Specifically, the embodiments described herein relate to adjusting for aftertreatment system condition and control within power generation systems.

Many power generation systems utilize an aftertreatment system to process the exhaust gases generated by the power generation system. In particular, aftertreatment systems may be used to reduce certain types of emissions by converting exhaust gases produced by the power generation system into other types of gases or liquids. For example, aftertreatment systems may be used to reduce the amount of nitrogen oxides within the exhaust gases. To reduce the amount of nitrogen oxides in the exhaust gases, an aftertreatment system may include one or more catalysts, such as a selective catalytic reduction (SCR) system to reduce the emissions of nitrogen oxides (NOx), hydrocarbons (HC), carbon monoxide (CO), and other emissions. However, the effectiveness of the aftertreatment systems at reducing emissions may decrease over time.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes an aftertreatment system configured to treat emissions from an engine via a catalyst and a controller. The controller is configured to obtain one or more engine signals representative of operations of the engine and to execute a model to derive an estimated catalyst emission based on the one or more engine signals and on an expected catalyst degradation. The controller is further configured to obtain one or more catalyst signals representative of catalyst performance, and to generate an adaptation signal configured to improve accuracy of the model based on the one or more catalyst signals. The controller is also configured to apply the adaptation signal and the estimated catalyst emission to generate a urea injection control signal.

In a second embodiment, electronic control unit includes a processor operatively coupled to a memory. The processor is programmed to execute instructions on the memory to obtain one or more engine signals representative of operations of an engine, and to execute a model to derive an estimated catalyst emission based on the one or more engine signals and on an expected catalyst degradation. The processor is additionally programmed to execute instructions on the memory to obtain one or more catalyst signals representative of catalyst performance, and to generate an adaptation signal configured to improve accuracy of the model based on the one or more catalyst signals. The processor is additionally programmed to execute instructions on the memory to apply the adaptation signal and the estimated catalyst emission to generate a urea injection control signal.

In a third embodiment, One or more non-transitory computer-readable media storing one or more processor-executable instructions wherein the one or more instructions, when executed by a processor of a controller, cause acts to be performed. The acts to be performed include obtaining one or more engine signals representative of operations of an engine, and executing a model to derive an estimated catalyst emission based on the one or more engine signals and on an expected catalyst degradation. The acts to be performed additionally include obtaining one or more catalyst signals representative of catalyst performance, and generating an adaptation signal configured to improve accuracy of the model based on the one or more catalyst signals. The acts to be performed further include applying the adaptation signal and the estimated catalyst emission to generate a urea injection control signal.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic view of a power generation system having an exhaust aftertreatment system, in accordance with an embodiment;

FIG. 2 is a block diagram of a control system for the power generation system of FIG. 1, in accordance with an embodiment;

FIG. 3 is a schematic view of the aftertreatment system of the power generation system of FIG. 1, in accordance with an embodiment;

FIG. 4 is an information flow diagram of an embodiment of a process suitable for adaptation-based control for the engine and aftertreatment system of FIG. 1; and

FIG. 5 is a flowchart illustrating a process suitable for generating and adaptation adjustment signal, and for controlling the aftertreatment system and/or engine of FIG. 1 based on the adaptation adjustment signal, in accordance with an embodiments.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Many power generation systems (e.g., combustion engines, turbine engines) use an aftertreatment system to condition the exhaust gases generated by the power generation system. For instance, certain power generation systems utilize aftertreatment systems that are designed to reduce the amount of nitrogen oxides in the exhaust gases. These aftertreatment systems may include one or more catalyst systems, such as selective catalytic reduction (SCR) systems. An SCR system may utilize a reductant injection, such as a urea injection, and a one or more catalysts to convert pollutants, such as NOx, HC, CO, to less toxic emissions. Unfortunately, subjecting the SCR system to certain operating conditions over time often causes changes in the number and type of active sites reactions may occur on. The loss of active sites on the surface of the catalysts can result in a loss of conversion performance (i.e., how well the catalyst is operating). As catalyst conversion performance decreases, the emissions of pollutants (e.g., NOx, HC, CO, etc.) from the engine can exceed emission compliance values (e.g., thresholds or requirements). By creating a “digital twin” that mirrors the behavior and performance of a specific SCR system, the techniques described herein may adapt urea injection controls of the engine based on the catalyst performance. Accordingly, the engine can remain in emissions compliance for a longer duration of time than if the urea injection were not adapted based on catalyst performance.

The disclosed embodiments include accounting for or obtaining one or more operating parameters of a combustion engine that may indicate a catalyst health for the SCR system. The operating parameters may include any actual or estimated aspects of the power production system performance (e.g., engine performance, current catalyst performance) suitable for indicating the performance of the catalysts, such as time (e.g., engine run time, catalyst aging time, times at different engine temperatures, etc.), temperatures, flow rates, and/or emission measurements. The catalyst health may describe how well the catalyst is performing at converting pollutants to less harmful emissions. Catalyst health may be monitored as a function of NOx emissions, NH₃ emissions, and other species emissions measured at locations post-catalyst in real time, as a part of a diagnostics module.

Once a discrepancy is recorded in the diagnostics module, an adaptation module may be activated. The adaptation module may take into account an operating time and actual behavior of the SCR system, e.g., providing features of a “digital twin” of the SCR, and a new oxygen storage set-point may be provided. The new oxygen storage set-point may be applied by controller embodiments to better accommodate an active site loss. The new oxygen storage set-point may be obtained through an online optimization-solving process that minimizes a model error in a target NOx and in a target CO emissions at post-catalyst locations, as described in more detail below. Urea control via the new set-point may then provide for improved catalyst and engine operations because an adjusted set-point may reflect or more closely model actual health and/or performance for the specific SCR system being controlled. Accordingly, urea injection and/or air-fuel ratio control of the engine, for example, may be more accurately provided.

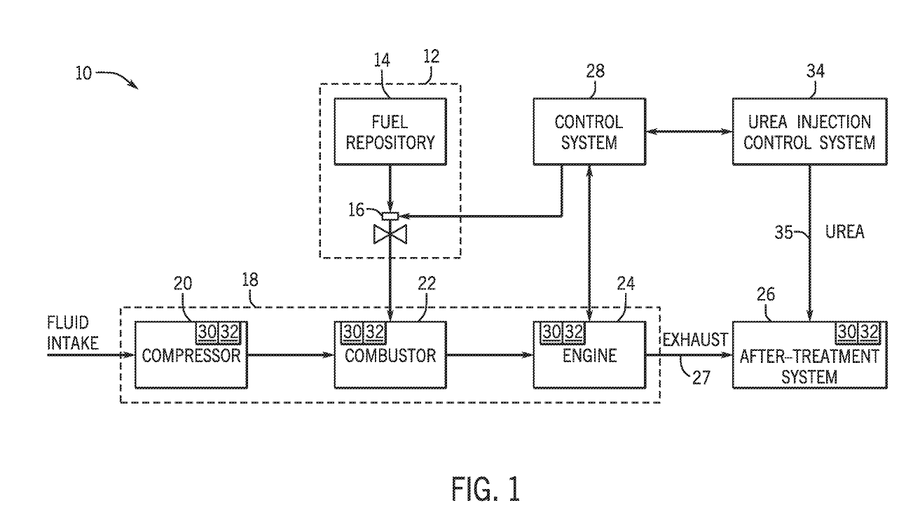

With the foregoing in mind, FIG. 1 depicts a power generation system 10 that may be used to provide power to a load, such as an electric generator, a mechanical load, and the like. The power generation system 10 includes a fuel supply system 12, which in turn includes a fuel repository 14 and a throttle 16 that controls the fuel flow from the fuel repository 14 and into the power generation system 10. The power generation system 10 also includes an engine system 18 which includes a compressor 20, a combustor 22, and a gas engine 24. Exemplary engine systems 18 may include General Electric Company's Jenbacher Engines (e.g., Jenbacher Type 2, Type 3, Type 4, Type 6 or J920 FleXtra) or Waukesha Engines (e.g., Waukesha VGF, VHP, APG, 275GL), for example. Further, the power generation system 10 includes an aftertreatment system 26, which is described in further detail below.

The power generation system 10 also includes a control system 28 which monitors various aspects of the operation of the power generation system 10. In particular, the control system 28 may work in conjunction with sensors 30 and actuators 32 to monitor and adjust the operation of the power generation system 10. For instance, various types of sensors 30, such as temperature sensors, oxygen sensors, fluid flow sensors, mass flow sensors, fluid composition sensors, and/or pressure sensors may be disposed on or in the components of the power generation system 10, and the throttle 16 is a specific actuator 32. Although the power generation system 10 is described as a gas engine system, it should be appreciated that other types of power generation systems (e.g., gas turbines, cold-day systems, combined cycle systems, co-generation systems, etc.) may be used and include the control system 28, aftertreatment system 26.

During operation, the fuel supply system 12 may provide fuel to the engine system 18 and, specifically, the combustor 22, via the throttle 16. Concurrently, the compressor 20 may intake a fluid (e.g., air or other oxidant), which may be compressed before it is sent to the combustor 22. Within the combustor 22, the received fuel mixes with the compressed fluid to create a fluid-fuel mixture which then combusts before flowing into the gas engine 24. The combusted fluid-fuel mixture drives the gas engine 24, which in turn produces power for suitable for driving a load. For example, the gas engine 24 may in turn drive a shaft connected to the load, such as a generator for producing energy. It is to be understood that the gas engine 24 may include internal combustion engines, gas turbine engines, and the like.

The combustion gases produced by the gas engine 24 exit the engine and vent as exhaust gases 27 into the aftertreatment system 26. In present embodiments, the exhaust gases 27 pass through one or more catalytic converter systems, which will be described in further detail below. In some embodiments, the exhaust gases 27 may also pass through a heat recovery steam generator (HRSG), which may recover the heat from the exhaust gases to produce steam. To monitor and adjust the performance of the aftertreatment system 26, the power generation system 10 includes a urea injection control system 34 which may inject a stream 35 of urea, described in further detail below. In certain embodiments, the urea injection control system 34 may be included as part of the control system 38. For example, as software stored in memory and executable via one or more processors. In other embodiments, the urea injection control system 34 may be a stand-alone system communicatively coupled to the control system 28.

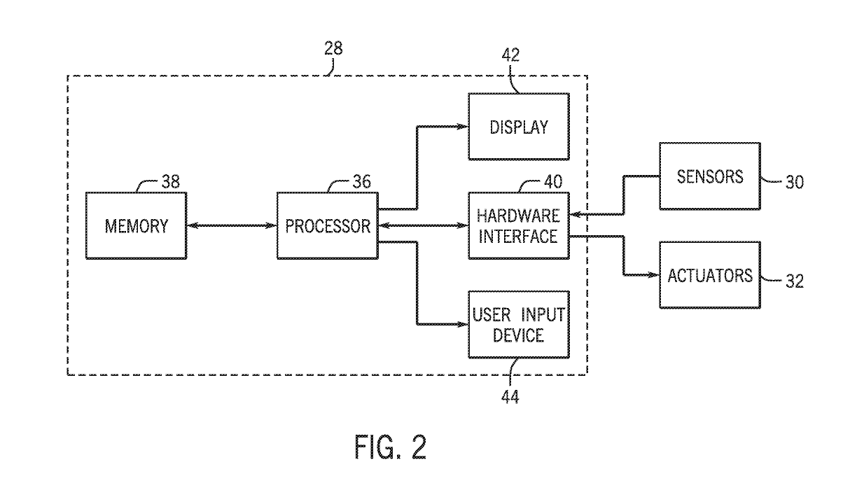

As mentioned earlier, the control system 28 (e.g., engine control unit [ECU]) oversees the operation of the power generation system 10. The control system 28 includes a processor 36, memory 38, and a hardware interface 40, as shown in FIG. 2. As depicted, the processor 36 and/or other data processing circuitry may be operably coupled to memory 38 to retrieve and execute instructions for managing the power generation system 10. For example, these instructions may be encoded in programs that are stored in memory 38, and the memory 38 may be an example of a tangible, non-transitory computer-readable medium. The instructions or code may be accessed and executed by the processor 36 to allow for the presently disclosed techniques to be executed. The memory 38 may be a mass storage device, a FLASH memory device, removable memory, or any other non-transitory computer-readable medium suitable for storing executable instructions or code. Additionally and/or alternatively, the instructions may be stored in an additional suitable article of manufacture that includes at least one tangible, non-transitory computer-readable medium that at least collectively stores these instructions or routines in a manner similar to the memory 38 as described above. The control system 28 may also communicate with the sensors 30 and the actuators 32 via the hardware interface 40. In some embodiments, the control system 28 may also include a display 42 and a user input device 44 to allow an operator to interact with the control system 28.

In some embodiments, the control system 28 may be a distributed control system (DCS) or similar multiple controller systems, such that each component (e.g., gas engine 24, aftertreatment system 26, urea injection control system 34 or group of components in the power generation system 10 includes or is associated with a controller for controlling the specific component(s). In these embodiments, each controller includes a processor, memory, and a hardware interface similar to the processor 36, the memory 38, and the hardware interface 40 described above. Each controller may also include a communicative link to communicate with the other controllers.

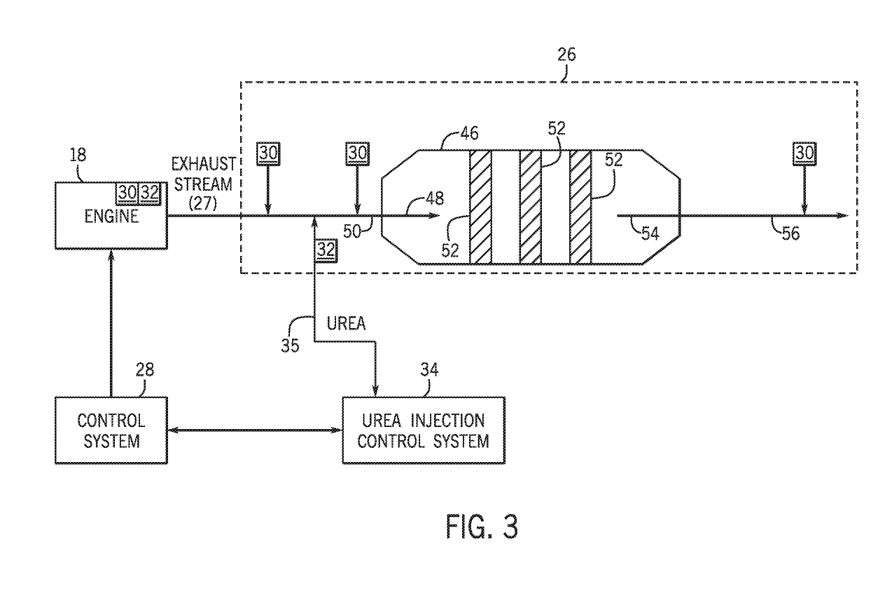

Turning now to FIG. 3, the figure is a block diagram of certain embodiments of components of the aftertreatment system 26, including a selective catalytic reduction (SCR) system 46 that receives and conditions the exhaust gas stream 27 exiting the gas engine 24. Because FIG. 3 includes like elements to FIGS. 1 and 2, the like elements are depicted with like numbers. Although the depicted embodiment depicts a single SCR system 46, it should be appreciated that the aftertreatment system 26 may include more than one SCR system 46 and/or any type of NOx reduction catalyst, as well as other catalytic converter systems and other components, such as the HRSG mentioned above.

The SCR system 46 is a particular type of exhaust catalyst used to convert nitrogen oxides into diatomic nitrogen (N₂) and water. To cause the desired reactions within the SCR catalyst 46, the urea stream 35 is injected into the exhaust gas stream 27 upstream of the SCR catalyst 46. The injection may be continuous, discrete, or a combination thereof, and may be controlled by the control system 28 and/or the urea injection control system 34, as will be described in further detail below. Further, while the embodiments described herein describe an injection of urea into the exhaust gas stream 27, it should be appreciated that the embodiments can be modified for any suitable gaseous reductant, e.g., anhydrous ammonia, aqueous ammonia.

In addition to being used in the gas engine system 24, SCR system 46 may also be used in utility boilers, industrial boilers, municipal solid waste boilers, diesel engines, diesel locomotives, gas turbines, and automobiles. An exhaust stream 48 including added urea may enter the SCR system 46 at an inlet 50. Before entering the SCR system 46, one or more sensors 30 may be used to determine certain properties of the exhaust stream 27, such as chemical composition, temperature, flow rate, pressure, and so on. In certain embodiment, the sensors 30 may include NH₃ sensors and/or NOx sensors suitable for measuring a concentration of ammonia and NOx in the exhaust stream 27, respectively. The sensors 30 may also include temperature sensors, oxygen sensors (e.g., lambda sensors), flow rate sensors, pressure sensors, and the like.

The SCR system 46 may include one or more honeycomb structures 52 that may be manufactured from various ceramic materials such as titanium oxide, and used as a carrier. The carrier material may carry active catalyst components, such as oxides of base metals. Active catalyst components may additionally or alternatively include precious metals. The SCR system 46 may convert NOx, for example, into N₂, water, and CO₂. For example, a reaction:

4NO+2(NH₂)₂CO+O₂→4N₂+4H₂O+2CO₂ Equation (1)

Equation (1) may be provided by the SCR system 46 when using urea. An exhaust stream 54 substantially devoid of NOx may then exit the SCR system 46. The exhaust stream 54 may be further processed, for example via other catalyst systems, e.g., ammonia slip catalyst (ASC), oxidation catalyst, and may then exit the aftertreatment system 26 as an exhaust stream 56.

After exiting the SCR system 46, other sensors 30 may be used to determine certain properties of the exhaust stream 56, such as chemical composition, temperature, flow rate, pressure, and so on. In certain embodiment, the post-SCR system 46 sensors 30 may include NH₃ sensors and/or NOx sensors suitable for measuring a concentration of ammonia and NOx in the exhaust stream 27, respectively. The exhaust stream 56 may then be released to ambient or be further processed by other component of the aftertreatment system 26.

The sensors 30 and components of the aftertreatment system 26 may be communicatively coupled to the urea injection control system 34. As stated above, the urea injection control system 34 may monitor the performance and the ongoing life of the aftertreatment system 26. In particular, the urea injection control system 34 may determine one or more adaptive adjustments and collaborate with the control system 28 to improve engine 18 control by applying the adaptive adjustments, for example, to modify injection of the urea during operations of the engine 18, as further described below. Further, the urea injection control system 34 may prompt diagnostic evaluations of and certain action (e.g., alarms, alerts, corrective actions) for the aftertreatment system 26.

The urea injection control system 34, as shown in FIG. 3, may be separate from the control system 28, and may contain a processor, memory, and a hardware interface similar to those of the control system 28. In other embodiments, the urea injection control system 34 may be part of the control system 28. For example, the urea injection control system 34 may reside in one of multiple controllers within a distributed control system, as described above, or may be provided as computer instructions executable via the control system 28.

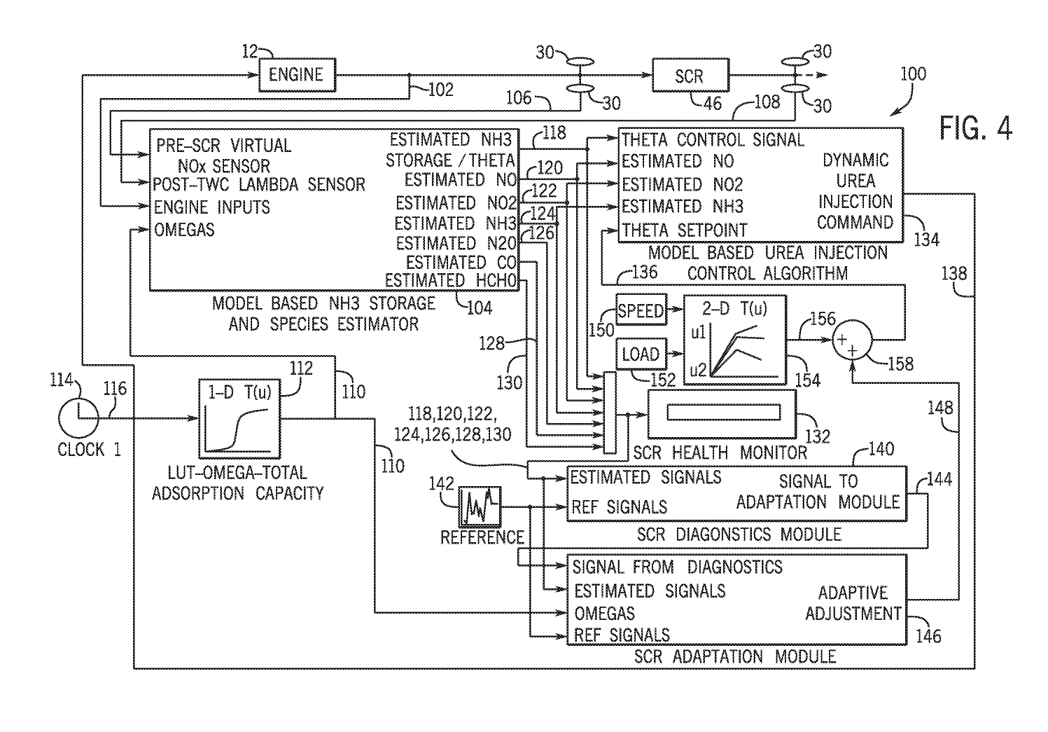

FIG. 4 is an information flow diagram of embodiments of a process 100 suitable for adaptation-based control for the aftertreatment system 26 and/or engine 18 of FIG. 1. The process 100 may be executed by the control system 28 and/or the urea injection control system 34 (e.g., utilizing the processor 36 to execute programs and access data stored on the memory 38). Because FIG. 4 includes like elements to FIGS. 1-3, the like elements are depicted with like numbers.

In the depicted embodiment, engine parameters 102 may be sensed during engine 18 operations, for example via the sensors 30 and provided to a model estimator 104. Likewise, pre-catalyst measurements 106 and post-catalyst measurements 108 may the communicated to the model estimator 104. Additionally, omega parameter(s) 110 may be derived, for example, via a total adsorption capacity lookup table (LUT) LUT_Omega 112. More specifically, to account for aging of the SCR system 46, a clock 114 may be utilized to provide an amount of time 116 (e.g., how long the SCR system 46 has been operating) based on clock cycles as counted by, for example, the processor 36. The omega parameter(s) 110 derived via the LUT 112 may indicate a total adsorption capacity for the SCR system 46. The adsorption capacity of the SCR system 46 may be reduced over time, for example, as NH₃ is adsorbed into various sited of the SCR system 46.

As such, the omega parameter derived via the LUT 112 may provide a deterioration factor that indicates how much the SCR system 46 has deteriorated (e.g., due to aging) based at least in part on one or more operating parameters, such as the time (e.g., from clock 114) and/or a component of the SCR system 46. The parameter(s) 110, may then be processed by the model estimator 104. The model estimator 104 may use the parameters 102, 106, 108, and/or 110 as input to derive an estimated NH₃ storage (theta) 118, an estimated NO emissions 120, an estimated NO₂ emissions 122, an estimated NO₃ emissions 124, an estimated N₂O 126 emissions, an estimated CO emissions 128, and an estimated HCHO 130 emissions. The model estimator 104 may include one or more physics-based models, such as chemical models, fluid dynamics models, and the like, that model the behavior of the exhaust streams 27, 48, 54, 56 as processed by the SCR system 46.

The estimated NH₃ storage 118 and estimated emissions 120, 122, 124, 126, 128, 130 may be monitored by a health monitor system 132. For example, the health monitor system 132 may display the estimated NH₃ storage 118 and estimated emissions 120, 122, 124, 126, 128, 130 for a user to view, and may additionally log the estimated NH₃ storage 118 and estimated emissions 120, 122, 124, 126, 128, 130. The estimated NH₃ storage 118 and estimated emissions 120, 122, 124, 126, 128, 130 may also be communicated to a urea injection control process 134. The urea injection control process 134 may additionally receive an adjusted theta set-point 136, as further described below. The urea injection control process 134 may then apply the estimated NH₃ storage 118 and estimated emissions 120, 122, 124, 126, 128, 130, and adjusted theta set-point 136 to derive a dynamic urea injection command 138. The dynamic urea injection command 138 may then be used to adjust urea in the stream 35, for example, by modulating the actuator 32 (shown in FIG. 3) to provide for the desired quantity of urea into the stream 27.

To derive the adjusted theta set-point 136, the process 100 may apply the estimated NH₃ storage 118 and estimated emissions 120, 122, 124, 126, 128, 130 to a SCR diagnostics module 140. The SCR diagnostics module 140 may include a set of reference signals 142, or be communicated the set of reference signals 142. The set of reference signals 142 may be used to diagnose the SCR system 46. For example, each of the estimated NH₃ storage 118 and estimated emissions 120, 122, 124, 126, 128, 130 may be compared to one or more of the reference signals 142, and if the estimated NH₃ storage 118 and/or estimated emissions 120, 122, 124, 126, 128, 130 is outside a desired range or value, the SCR diagnostics module 140 may communicate a signal 144 to a SCR adaption module 146. The SCR adaptation module 146 may use the signal 144 and/or a time-based trigger (e.g., starting execution of the SCR adaptation module 146 after a certain elapsed catalyst operation time of SCR system 46 and/or engine 18 exceeds a desired time value, such as after operations of the SCR system 46 and/or the engine 18 have exceeded a time of between 10-10000 hours). In operations, the SCR adaptation module 146 may apply as inputs estimated NH₃ storage 118 and/or estimated emissions 120, 122, 124, 126, 128, 130, the omega parameters 110 (e.g., degradation parameters found via LUT 112), and the reference signals 142 to derive an adaptive adjustment signal 148.

The adaptive adjustment signal 148 may be derived, for example, by applying techniques that correct for or minimize errors in the model estimator 104. In one embodiment, a theta (e.g., oxygen storage) set-point Θₛₚ is identified or derived by a real-time optimization or minimization of J=f(e_{NO}_{ₓ},e_{NH}_{₃}) where J is a function of a NOx error and a NH₃ error (e.g., e_{NO}_{ₓ}) and a NH₃ error (e.g., e_{NH}_{₃}) measured via post-SCR system 46 sensors 30. That is, sensors 30 disposed downstream of the SCR system 46 may measure the exhaust stream 56 for NOx and NH₃ concentrations (as well as other species), and based on this measure, for example, compare the NOx and NH₃ concentrations with the estimated NOx 120, 122, 124, as well as compare measurements to estimates 126-130 to find the errors e_{NOx} and e_{NH}_{₃}. Absolute value differences (e.g., errors e_{NOx} and e_{NH}_{₃}) between the measured NOx and NH₃ concentrations and the estimates 120-130 may then be used to identify the theta set-point Θₛₚ that may minimize or eliminate such differences, e.g., bring the errors to zero or close to zero. The real-time optimization may include techniques such as algebraic sum of errors (e.g., algebraic sum of the errors e_{NOx} and e_{NH}_{₃}), sum of root mean square estimate of errors e_{NOx} and e_{NH}_{₃}, or a combination thereof.

The process 100 may apply an engine speed 150 and a load 152 as inputs to a lookup table (LUT) 154. The LUT 154 may be a 2-dimensional LUT that maps speed and load to a theta set-point. Accordingly, the inputted speed 150 and load 152 may be processed by the LUT 154 to result in an un-adjusted theta set-point 156. The un-adjusted theta set-point 156 may be adjusted via the adaptive signal 146 by an adjustment module 158 to derive the adjusted theta set-point 136 based on the desired theta set-point Θₛₚ. Accordingly, the adjusted theta set-point 136 may minimize or eliminate model estimator 104 errors, and the resulting dynamic urea injection command may more accurately provide for a urea quantity in the stream 35 that enables emissions compliance for an extended duration of time.

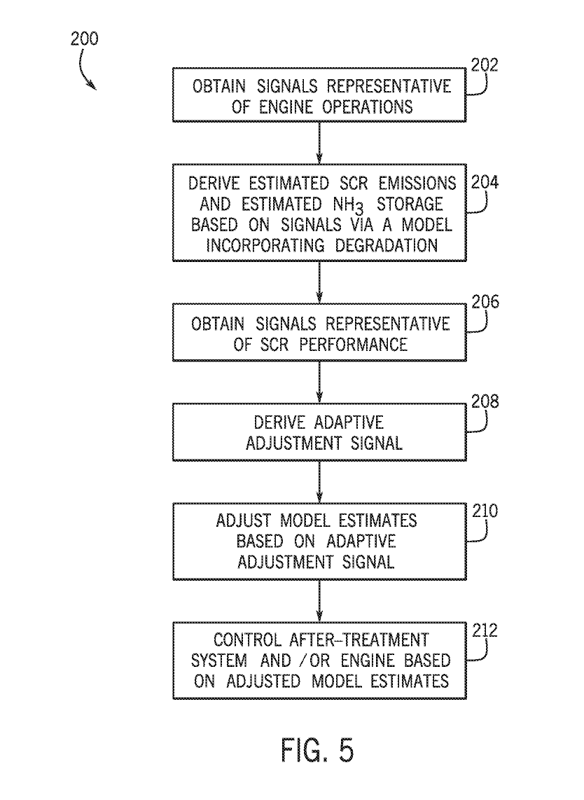

FIG. 5 is a flowchart of an embodiment of a process 200 suitable for generating the adaptation adjustment signal 148 shown in FIG. 4, and controlling the aftertreatment system 26 and/o engine 18 based on the adaptation adjustment signal 148. The process 200 may be implemented as computer code or instructions stored in the memory 38 and executable via the processor 36. In the depicted embodiment, the process 200 may obtain (block 202) signals representative of engine and aftertreatment 26 operations, such as signals 102, 106. The process 200 may then derive (block 204) via the model estimator 104 one or more estimated SCR emissions 120, 122, 124, 126, 128, 130 as well as derive (block 204) the estimated NH₃ storage 120. The derivations (block 204) may incorporate SCR degradation factors, such as by applying the LUT 112 to derive the estimated total adsorption capacity 110 for the SCR system 46.

The process 200 may then obtain (block 206) one or more signals representative of performance of the SCR system 46 performance, such as signals 108. The adaptive adjustment signal 148 may then be derived (block 208). In one embodiment, the adaptive adjustment signal 142 may be derived by identifying the theta (e.g., oxygen storage) set-point Θₛₚ that may minimize modeling errors (e.g., errors from the model estimator 104), and may also incorporate the degradation parameters 110. Accordingly, in one embodiment, the process 200 may minimize the function J=f(e_{NOx}, e_{NH}_{₃}) where J is a function of the exhaust NOx (e.g., e_{NO}_{ₓ}) and exhaust NH₃ (e.g., e_{NH}_{₃}). The adaptive adjustment signal 148 may be derived (block 208) based on time, e.g., such as after a desired operating time for the SCR system 46 and/or the engine 18. The adaptive adjustment signal 148 may additionally or alternatively be derived (block 208) based on the signal 144 transmitted via the SCR diagnostic module 140.

The process 200 may then adjust (block 210) model estimates such as the adjusted theta set-point 136. To adjust (block 210) the adjusted theta set-point 136, the process 200 may apply the adaptive adjustment signal 148 to the un-adjusted theta set-point 156 to derive the adjusted theta set-point 136. The un-adjusted theta set-point 156 may be derived by applying speed 150 and load 152 to the LUT 154 mapping speed and load to a desired theta. The process 200 may then control (block 212) the aftertreatment system 12 and/or engine 18. For example, the process 200 may adjust the urea entering stream 35 by applying the adjusted model estimates. Additionally or alternatively, the process 200 may adjust oxidant (e.g., air) intake, adjust fuel throttle position, and so on, based on the adjusted model estimates. By adapting aftertreatment and/or engine control to more closely model the behavior of the SCR system 46 and engine 18, the techniques described herein may improve aftertreatment and/or engine control and increase emissions compliance.

Technical effects of the invention include monitoring and adjusting the operation of an aftertreatment system and/or an engine of a power generation system. Certain embodiments enable adjusting operating set-points of the engine based on degradation and based on actual aftertreatment system and engine performance to improve the control and operations of the engine and the aftertreatment system. For instance, a theta set-point may be adjusted based both modeled degradation as well as actual performance of the aftertreatment system and the engine. The adjusted theta set-point may then be used to control aftertreatment operations and/or operations of the engine.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
an aftertreatment system configured to treat emissions from an engine via a catalyst; and
a controller configured to:
obtain one or more engine signals representative of operations of the engine;
execute a model to derive an estimated catalyst emission based on the one or more engine signals and on an expected catalyst degradation;
obtain one or more catalyst signals representative of catalyst performance;
generate an adaptation signal configured to improve accuracy of the model based on the one or more catalyst signals; and
apply the adaptation signal and the estimated catalyst emission to generate a urea injection control signal.

2. The system of claim 1, wherein the controller is configured to analyze a difference between a reference signal and the estimated catalyst emission and to generate the adaptation signal based on the difference.

3. The system of claim 2, wherein the reference signal comprises an NH₃ emissions reference signal, a NOx emissions reference signal, a CO emissions reference signal, a HCHO emissions reference signal, or a combination thereof.

4. The system of claim 1, wherein the controller is configured to execute the model to derive an estimated NH₃ catalyst storage based on the one or more engine signals and on the expected catalyst degradation, and wherein the controller is configured to apply the estimated NH₃ catalyst storage, the adaptation signal, and the estimated catalyst emission to generate the urea injection control signal.

5. The system of claim 1, wherein the controller is configured to derive the expected catalyst degradation based on applying an elapsed catalyst operation time to a total adsorption capacity lookup table.

6. The system of claim 1, wherein the controller is configured to apply the adaptation signal to derive a corrected ammonia storage theta set-point, and wherein the controller is configured to apply the corrected theta set-point, the adaptation signal and the estimated catalyst emission to generate the urea injection control signal.

7. The system of claim 1, wherein the estimated catalyst emission comprises an estimated NO emissions, an estimated NO₂ emissions, an estimated NH₃ emissions, an estimated N₂O emissions, an estimated CO emissions, an estimated HCHO emissions, or a combination thereof.

8. The system of claim 1, wherein the controller is configured to generate the adaptation signal by deriving a desired theta set-point based on a real-time optimization of a function J=f(e_{NO}_{ₓ},e_{NH}_{₃}) where e_{NO}_{ₓ} is a nitrogen oxide (NOx) error derived by computing a first absolute difference between an estimated NOx emission derived via the model and a measured NOx emission sensed from a NOx sensor disposed downstream of the catalyst, and e_{NH}_{₃} is an ammonia error derived by computing a second absolute difference between an estimated ammonia emission derived via the model and a measured ammonia emission sensed from an ammonia sensor disposed downstream of the catalyst, and wherein the real-time optimization comprises an algebraic sum of errors, a sum of root mean square estimate of errors, or a combination thereof.

9. The system of claim 1 wherein the catalyst comprises a selective catalytic reduction (SCR) system.

10. An electronic control unit, comprising:
a processor operatively coupled to a memory, wherein the processor is programmed to execute instructions on the memory to:
obtain one or more engine signals representative of operations of an engine;
execute a model to derive an estimated catalyst emission based on the one or more engine signals and on an expected catalyst degradation;
obtain one or more catalyst signals representative of catalyst performance;
generate an adaptation signal configured to improve accuracy of the model based on the one or more catalyst signals; and
apply the adaptation signal and the estimated catalyst emission to generate a urea injection control signal.

11. The electronic control unit of claim 10, wherein the processor is programmed to execute instructions on the memory to analyze a difference between a reference signal and the estimated catalyst emission and to generate the adaptation signal based on the difference.

12. The electronic control unit of claim 10, wherein the processor is programmed to execute instructions on the memory to execute the model to derive an estimated NH₃ catalyst storage based on the one or more engine signals and on the expected catalyst degradation, and wherein the controller is configured to apply the estimated NH₃ catalyst storage, the adaptation signal, and the estimated catalyst emission to generate the urea injection control signal.

13. The electronic control unit of claim 10, wherein the processor is programmed to execute instructions on the memory to derive the expected catalyst degradation based on applying an elapsed catalyst operation time to a total adsorption capacity lookup table.

14. The electronic control unit of claim 10, wherein the processor is programmed to execute instructions on the memory to generate adaptation signal by deriving a desired theta set-point based on a real-time optimization of a function J=f(e_{NO}_{ₓ},e_{NH}_{₃}) where e_{NOx} is a nitrogen oxide (NOx) error derived by computing a first absolute difference between an estimated NOx emission derived via the model and a measured NOx emission sensed from a NOx sensor disposed downstream of the catalyst, and e_{NH}_{₃} is an ammonia error derived by computing a second absolute difference between an estimated ammonia emission derived via the model and a measured ammonia emission sensed from an ammonia sensor disposed downstream of the catalyst, and wherein the real-time optimization comprises an algebraic sum of errors, a sum of root mean square estimate of errors, or a combination thereof.

15. One or more non-transitory computer-readable media storing one or more processor-executable instructions wherein the one or more instructions, when executed by a processor of a controller, cause acts to be performed comprising:
obtaining one or more engine signals representative of operations of an engine;
executing a model to derive an estimated catalyst emission based on the one or more engine signals and on an expected catalyst degradation;
obtaining one or more catalyst signals representative of catalyst performance;
generating an adaptation signal configured to improve accuracy of the model based on the one or more catalyst signals; and
applying the adaptation signal and the estimated catalyst emission to generate a urea injection control signal.

16. The non-transitory computer readable medium of claim 15, wherein the acts to be performed comprise analyzing a difference between a reference signal and the estimated catalyst emission and to generate the adaptation signal based on the difference.

17. The non-transitory computer readable medium of claim 16, wherein the reference signal comprises an NH₃ emissions reference signal, a NOx emissions reference signal, a CO emissions reference signal, a HCHO emissions reference signal, or a combination thereof.

18. The non-transitory computer readable medium of claim 15, wherein the acts to be performed comprise executing the model to derive an estimated NH₃ catalyst storage based on the one or more engine signals and on the expected catalyst degradation, and wherein the controller is configured to apply the estimated NH₃ catalyst storage, the adaptation signal, and the estimated catalyst emission to generate the urea injection control signal.

19. The non-transitory computer readable medium of claim 15, wherein the acts to be performed comprise deriving the expected catalyst degradation based on applying an elapsed catalyst operation time to a total adsorption capacity lookup table.

20. The non-transitory computer readable medium of claim 15, wherein the acts to be performed comprise generating the adaptation signal by deriving a desired theta set-point based on a real-time optimization of a function J=f(e_{NO}_{ₓ},e_{NH}_{₃}) where e_{NOx} is a nitrogen oxide (NOx) error derived by computing a first absolute difference between an estimated NOx emission derived via the model and a measured NOx emission sensed from a NOx sensor disposed downstream of the catalyst, and e_{NH}_{₃} is an ammonia error derived by computing a second absolute difference between an estimated ammonia emission derived via the model and a measured ammonia emission sensed from an ammonia sensor disposed downstream of the catalyst, and wherein the real-time optimization comprises an algebraic sum of errors, a sum of root mean square estimate of errors, or a combination thereof.
